(19) United States
(12) Patent Application Publication
(10) Pub. No.: US 2011/0161830 A1
(43) Pub. Date: Jun. 30, 2011

(54) FACETED PROFILES WITH CUSTOMIZED PRIVACY CONTROLS AND PERSONALIZED VIEW

(75) Inventors: STEPHEN P. KRUGER, DUBLIN (IE); CHRISTOPHER J. PAUL, DURHAM, NC (US); ANUPHINH P. WANDERSKI, DURHAM, NC (US); ROBERT L. YATES, ARLINGTON, MA (US)

(73) Assignee: INTERNATIONAL BUSINESS MACHINES CORPORATION, ARMONK, NY (US)

(21) Appl. No.: 12/650,163

(22) Filed: Dec. 30, 2009

(51) Int. Cl. H04L 9/32; G06F 3/048; G06F 15/16

(52) U.S. Cl. 715/741; 715/733

(57) ABSTRACT

An entity's profile is augmented. Viewer-supplied data is received from a first viewing computer to modify an initial profile for a profiled entity in order to create an augmented profile about the profiled entity. This viewer-supplied data is hidden from the profiled entity. The augmented profile is generated and transmitted to an authorized viewing computer that has requested the augmented profile.

### BACKGROUND

The present disclosure relates to the field of computers, and specifically to information that is shared and displayed on computers. Still more particularly, the present disclosure relates to user profiles that are displayed on computers.

### BRIEF SUMMARY

A computer-implemented method, system and computer program product for augmenting an entity's profile is presented. Viewer-supplied data is received from a first viewing computer to modify an initial profile for a profiled entity in order to create an augmented profile about the profiled entity. This viewer-supplied data is hidden from the profiled entity. The augmented profile is generated and transmitted to an authorized viewing computer that has requested the augmented profile.

### BRIEF DESCRIPTION OF THE SEVERAL VIEWS OF THE DRAWINGS

FIG. 1 depicts an exemplary computer in which the present invention may be implemented;

FIG. 2 illustrates an exemplary graphical user interface (GUI) displaying a profiled entity's initial profile;

FIG. 3 depicts a preliminary augmented version of the profiled entity's initial profile shown in FIG. 2;

FIG. 4 illustrates a GUI that is used to create notes that contain data that is used to augment the profiled entity's profile;

FIG. 5 depicts a fully configured version of the preliminary augmented profiled entity's profile shown in FIG. 3;

FIG. 6 illustrates an exemplary network of computers used in one embodiment of the present disclosure; and

FIG. 7 is a high-level flow-chart of exemplary steps processed by a computer to modify and manage profiled entities' profiles.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

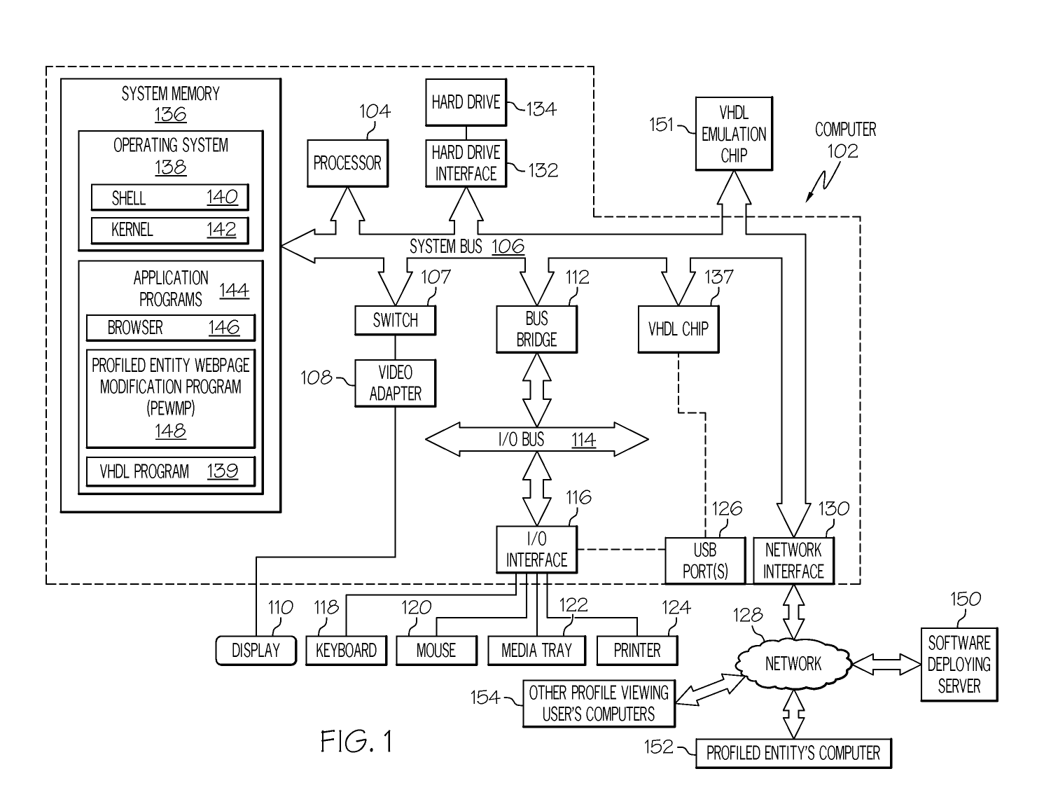

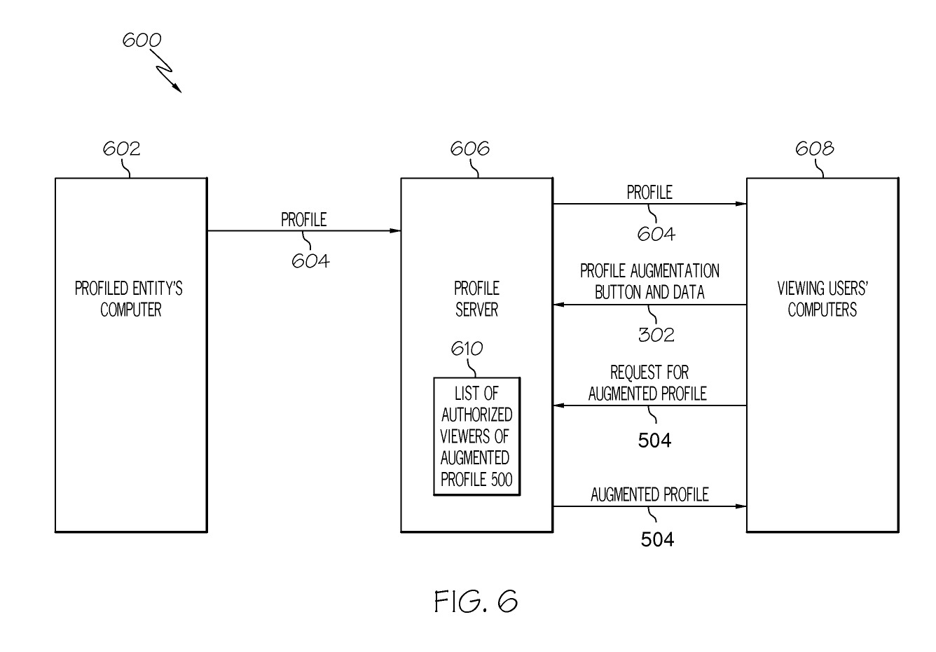

With reference now to the figures, and in particular to FIG. 1, there is depicted a block diagram of an exemplary computer 102, which may be utilized by the present invention. Note that some or all of the exemplary architecture, including both depicted hardware and software, shown for and within computer 102 may be utilized by software deploying server 150, profiled entity's computer 152, and/or other profile viewing users' computers 154, as well as profiled entity's computer 602, profile server 606, and viewing users' computers 608 shown in FIG. 6.

Computer 102 includes a processor 104 that is coupled to a system bus 106. Processor 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, preferably mechanical, that allows the display 110 to be coupled to the system bus 106, and thus to be functional only upon execution of instructions (e.g., profiled entity webpage modification program—PEWMP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in a preferred embodiment some or all of these ports are universal serial bus (USB) ports.

As depicted, computer 102 is able to communicate with a software deploying server 150 and a sender's SMTP server 152 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In a preferred embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

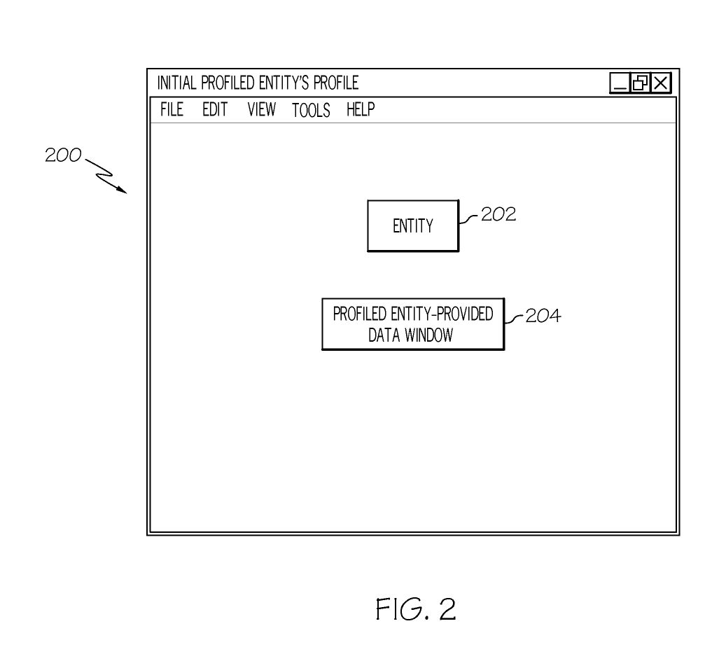

Application programs 144 in computer 102's system memory (as well as software deploying server 150's system memory and profile webpage server 604's system memory) also include profiled entity webpage modification program (PEWMP) 148. PEWMP 148 includes code for implementing the processes described below, including those described in FIGS. 2-7. In one embodiment, computer 102 is able to download PEWMP 148 from software deploying server 150, including in an on-demand basis. Note further that, in one embodiment of the present invention, software deploying server 150 performs all of the functions associated with the present invention (including execution of PEWMP 148), thus freeing computer 102 from having to use its own internal computing resources to execute PEWMP 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from PEWMP 148 causes VHDL program 139 to configure VHDL chip 137, which may be an FPGA, ASIC, etc.

In another embodiment of the present invention, execution of instructions from PEWMP 148 results in a utilization of VHDL program 139 to program a VHDL emulation chip 151. VHDL emulation chip 151 may incorporate a similar architecture as described above for VHDL chip 137. Once PEWMP 148 and VHDL program 139 program VHDL emulation chip 151, VHDL emulation chip 151 performs, as hardware, some or all functions described by one or more executions of some or all of the instructions found in PEWMP 148. That is, the VHDL emulation chip 151 is a hardware emulation of some or all of the software instructions found in PEWMP 148. In one embodiment, VHDL emulation chip 151 is a programmable read only memory (PROM) that, once burned in accordance with instructions from PEWMP 148 and VHDL program 139, is permanently transformed into a new circuitry that performs the functions needed to perform the process described below in FIGS. 2-7.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

With reference now to FIG. 2, an exemplary graphical user interface (GUI) 200 displaying an initial profiled entity's profile is presented. This profile may be for an enterprise, a work group, a person, or any other user-defined entity. Note that in the initial profile, the entity has supplied data about itself in profiled entity-provided data window 204. However, viewing users may want to know more information about the profiled entity 202, including information that is provided by others who are familiar with it.

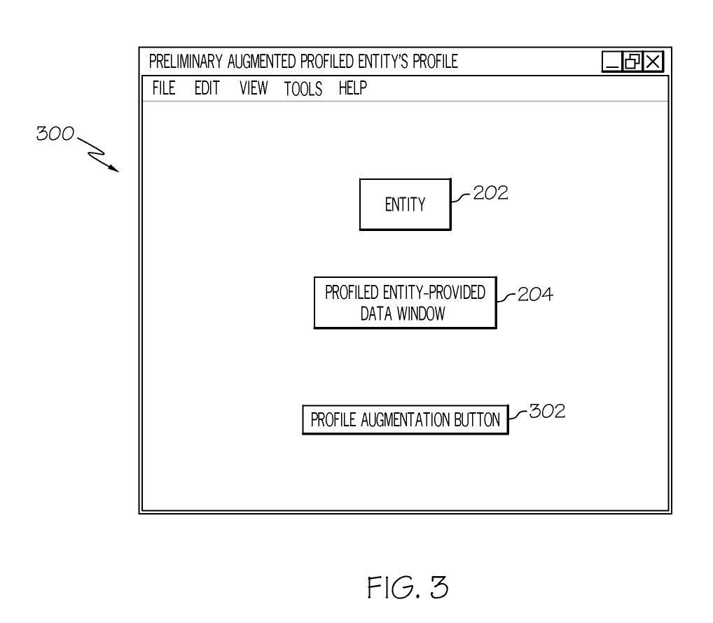

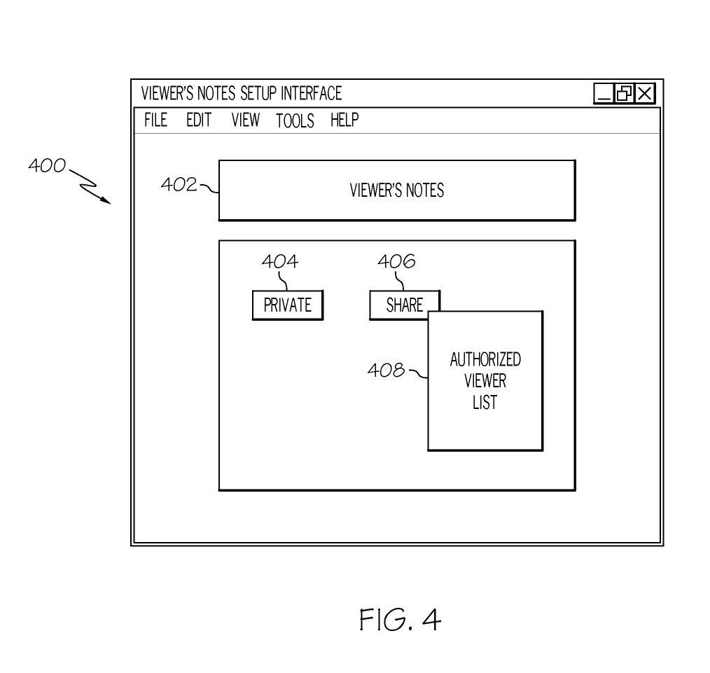

With reference now to FIG. 3, a preliminary augmented profiled entity's profile is shown in a GUI 300. This GUI 300 is similar to the GUI 200 shown in FIG. 2, with the addition of a profile augmentation button 302, which has been added by a first viewing user through the use of a profile server. By clicking this profile augmentation button 302, a private profile augmentation setup user interface (shown in the GUI 400 in FIG. 4) is pulled up and presented to the first viewing user. This GUI 400 allows the first viewing user to enter his own viewer's notes 402 about the profiled entity 202. Such notes may include general comments about the profiled entity 202, or may include detailed information about the profiled entity 202, such as past experiences the viewing entity has had with the profiled entity 202. In one embodiment, the viewer's notes may build on top of the initial profile about the profiled entity (e.g., data found in the profiled entity-provided data window 204 shown in FIG. 2). In another embodiment, the viewer's notes are newly developed by the viewer, and may include text data, bookmarks, photos, links, etc. that the viewer deems applicable to describe the profiled entity. Once the first viewing user has entered her viewer's notes, she can then decide whether they are to viewed in the future by only herself (by clicking the private button 404), or if she wants to share her notes with other viewing users (by clicking the share button 406). If the share button 406 is clicked, then the first viewing entity defines who else can view her notes by defining an authorized viewer list 408. This authorized viewer list 408 may be made up of individuals named by the first viewing user, or it may be a made up of some pre-defined group, such as a work group in an enterprise, an enterprise's department, etc.

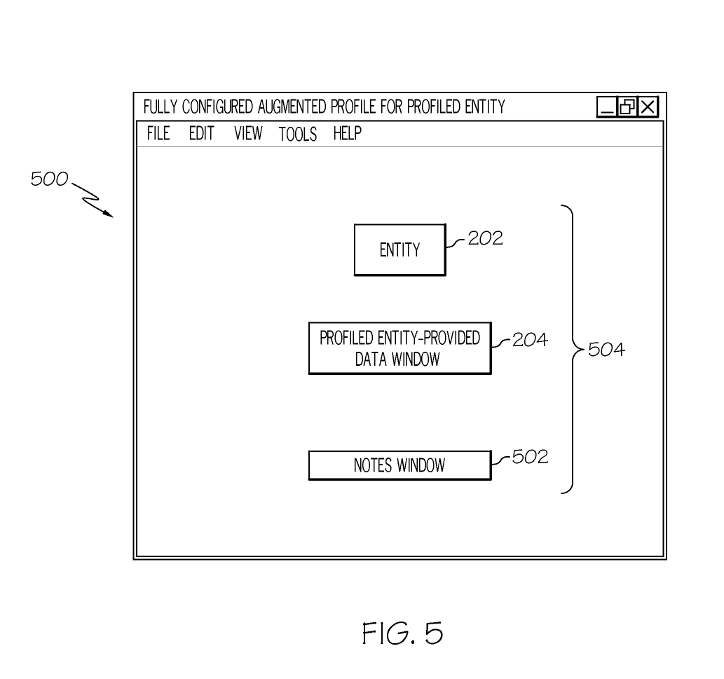

With reference now to FIG. 5, a GUI 500 showing a fully configured augmented profile for a profiled entity is presented. Note that this GUI 500 includes a notes window 502, which includes notes (and other viewer-supplied information) about the profiled entity 202 to create an augmented profile 504. These notes were initially entered by the first viewing user described above. In one embodiment, other members of the authorized view list 408 (if further authorized by the first viewing user) are also able to enter their own notes about the profiled entity 202 into the notes window 502, such that these other members are able to add onto the comments entered by the first viewing user. Note that, in one embodiment, the profiled entity 202 is never able to view the contents of the notes window 502, nor can he even see that the notes window 502 exists. Furthermore, when any user other than the first viewing user or any other authorized viewing user requests a profile for the profiled entity, she will receive GUI 200 (shown in FIG. 2) instead of GUI 500 (shown in FIG. 5). That is, if the profiled entity 202 itself, as well as any other unauthorized entity, requests a webpage for the profiled entity, it will receive a webpage that presents GUI 200 instead of GUI 500 in response to that request.

With reference now to FIG. 6, a high-level overview of a network 600 and steps taken to create the augmented profile for a profiled entity are presented. A profiled entity's computer 602 (used by the profiled user 202 described above and analogous to profiled entity's computer 152 shown above in FIG. 1) sends a profile 604 (from GUI 200 in FIG. 2) for the profiled entity to a profile server 606 (analogous to computer 102 shown in FIG. 1). A first viewing user, using one of the viewing users' computers 608 (analogous to other profile viewing users' computers 154 shown in FIG. 1), requests and receives that profile 604. However, as described above, the first viewing user desires to add his own data, which is about the profiled entity but will always be hidden from the profiled entity, to the profile 604 in order to create the augmented profile 504 (shown in FIG. 5). The first viewing user therefore will then instruct the profile server 606 to create augmented profile 504 by clicking the profile augmentation button 302 shown above in FIG. 3. This results in the profile server 600 sending the profile augmentation template (e.g., the viewer's notes 402 window shown in FIG. 4) to the first viewing user, who fills in his version of the viewer's notes, information about who can view these notes (added to list 610 in the profile webpage server 606), etc.

Subsequently, any user, whether it be the first viewing user or another authorized viewing user, who is using one of the viewing users' computers 608 sends a requests for the augmented profile 504 (depicted in GUI 500 in FIG. 5). The profile server 606 returns augmented profile 504 to the authorized requester, who may or may not be authorized to add, delete, edit, or otherwise modify the augmented profile 504.

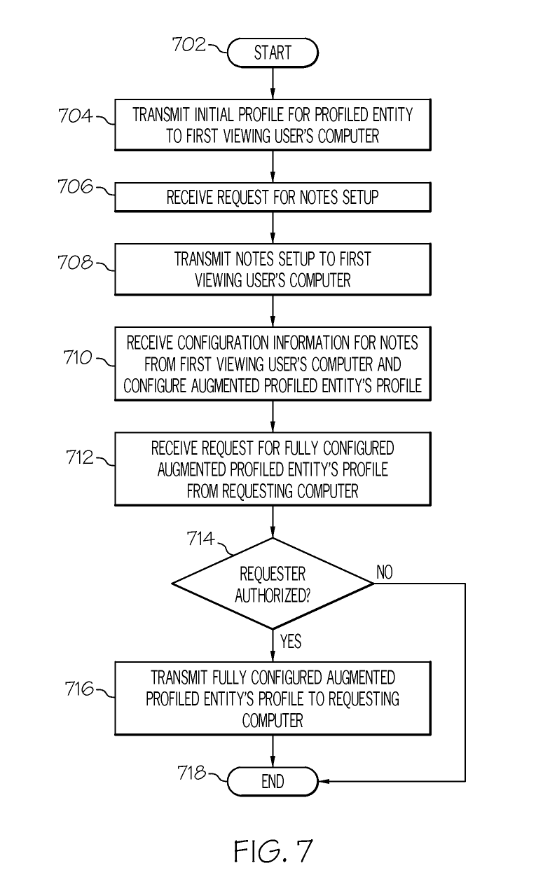

With reference now to FIG. 7, a high-level flowchart of exemplary steps taken to modify a profile for a profiled entity is presented. After initiator block 702, a profile server transmits an initial profile for a profiled entity to a first viewing computer (block 704). The profile server then receives a request, from the first viewing computer, to set up a notes window in order to create an augmented profile for the profiled entity (block 706). This augmented profile comprises information that can be entered into a notes window for displaying viewer-supplied information about the profiled entity. Note that this viewer-supplied information is not provided by the profiled entity itself. In one embodiment, the viewer-supplied information is always hidden from the profiled entity.

As described in block 708, a notes setup is transmitted to a first viewing user of the first viewing computer. After the first viewing user enters his initial viewer-supplied notes and other information and parameters related to these notes (i.e., who can view them, how they are presented on a webpage or other publicly viewed resource, etc.), the information and parameters are received by the webpage server (block 710). The profile server then utilizes this information to modify the initial profiled entity's profile (e.g., as shown in GUI 200 in FIG. 2) into the augmented profiled entity's profile (e.g., as shown in GUI 500 in FIG. 5.)

Thereafter, a request for that augmented profiled entity's profile may be received (block 712). If the requester is authorized (query block 714), then the augmented profiled entity's profile is transmitted to the requester (block 716). In one embodiment, the augmented profile is displayed on an augmented profile webpage for the profiled entity. This augmented profile webpage may comprise multiple notes windows, wherein the multiple notes windows are set by multiple viewing users, and wherein none of the multiple notes windows are set by or visible to the profiled entity. If the requester is not authorized, then the process ends at terminator block 718.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A computer-implemented method of augmenting an entity's profile, the computer-implemented method comprising:
a processor receiving, from a first viewing computer, viewer-supplied data to modify an initial profile for a profiled entity in order to create an augmented profile about the profiled entity, wherein the viewer-supplied data in the augmented profile is hidden from the profiled entity;
generating the augmented profile;
receiving a request for the augmented profile from an authorized viewing computer; and
transmitting the augmented profile to the authorized viewing computer.

2. The computer-implemented method of claim 1, wherein the profiled entity is an enterprise.

3. The computer-implemented method of claim 1, wherein the authorized viewing computer is identified by authorization information received from the first viewing computer.

4. The computer-implemented method of claim 3, wherein only a user of the first viewing computer is authorized to view the augmented profile.

5. The computer-implemented method of claim 3, wherein only users on an authorized users list set by a user of the first viewing computer are authorized to view the augmented profile.

6. The computer-implemented method of claim 5, wherein any user on the authorized users list is authorized to further augment the augmented profile about the profiled entity.

7. The computer-implemented method of claim 1, wherein only a user of the first viewing computer is authorized to populate the augmented profile with data.

8. The computer-implemented method of claim 7, wherein the authorized users list is limited to members of a work group in an enterprise.

9. The computer-implemented method of claim 1, wherein the augmented profile is displayed on an augmented profile webpage for the profiled entity, wherein the augmented profile webpage comprises multiple notes windows, wherein the multiple notes windows are set by multiple viewing users, and wherein none of the multiple notes windows are set by or visible to the profiled entity.

10. A computer program product comprising a computer readable storage medium embodied therewith, the computer readable storage medium comprising:
computer readable program code configured to receive, from a first viewing computer, viewer-supplied data to modify an initial profile for a profiled entity in order to create an augmented profile about the profiled entity, wherein the viewer-supplied data in the augmented profile is hidden from the profiled entity;
computer readable program code configured to generate the augmented profile;
computer readable program code configured to receive a request for the augmented profile from an authorized viewing computer; and
computer readable program code configured to transmit the augmented profile to the authorized viewing computer.

11. The computer program product of claim 10, wherein the profiled entity is an enterprise.

12. The computer program product of claim 10, wherein the authorized viewing computer is identified by authorization information received from the first viewing computer.

13. The computer program product of claim 12, wherein only a user of the first viewing computer is authorized to view the augmented profile.

14. The computer program product of claim 12, wherein only users on an authorized users list set by a user of the first viewing computer are authorized to view the augmented profile.

15. The computer program product of claim 14, wherein any user on the authorized users list is authorized to further augment the augmented profile about the profiled entity.

16. The computer program product of claim 10, wherein only a user of the first viewing computer is authorized to populate the augmented profile with data.

17. The computer program product of claim 16, wherein the authorized users list is limited to members of a work group in an enterprise.

18. The computer program product of claim 10, wherein the augmented profile is displayed on an augmented profile webpage for the profiled entity, wherein the augmented profile webpage comprises multiple notes windows, wherein the multiple notes windows are set by multiple viewing users, and wherein none of the multiple notes windows are set by or visible to the profiled entity.

19. A computer system comprising:
a central processing unit; and
a computer readable memory coupled to the central processing unit, wherein the computer readable memory comprises software that, when executed, causes the central processing unit to implement:
receiving, from a first viewing computer, viewer-supplied data to modify an initial profile for a profiled entity in order to create an augmented profile about the profiled entity, wherein the viewer-supplied data in the augmented profile is hidden from the profiled entity;
generating the augmented profile;
receiving a request for the augmented profile from an authorized viewing computer; and
transmitting the augmented profile to the authorized viewing computer.

20. The computer system of claim 19, wherein the profiled entity is an enterprise.
